(19) United States
(12) Patent Application Publication
(10) Pub. No.: US 2010/0134376 A1
(43) Pub. Date: Jun. 3, 2010

(54) WIDEBAND RF 3D TRANSITIONS

(75) Inventors: Alexandros Margomenos, Ann Arbor, MI (US); Amin Rida, Atlanta, GA (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Motor Engineering & Manufacturing North America, Inc., Erlanger, KY (US)

(21) Appl. No.: 12/325,652

(22) Filed: Dec. 1, 2008

(51) Int. Cl. H01Q 1/38; H01Q 1/48; H01Q 1/50

(52) U.S. Cl. 343/848; 343/700 MS; 343/860

(57) ABSTRACT

Apparatus and methods according to examples of the present invention include providing an electrical interconnection between an RF circuit and an antenna, the electrical interconnection including a transition via through an antenna substrate. The electrical connection can be configured so as to provide low losses.

### FIELD OF THE INVENTION

The invention relates to electromagnetic devices, for example radar antennas.

### BACKGROUND OF THE INTENTION

Antennas are useful for a variety of applications, for example automotive radar applications. A low cost antenna is highly desirable. However, current state-of-the-art automotive radars are expensive and bulky.

### SUMMARY OF THE INVENTION

Embodiments of the present invention relate to microwave applications, in particular millimeter wave antennas including automotive radar antennas. Examples of the present invention include improved apparatus and methods for 3D transitions between an RF circuit and an antenna, in particular using a low loss RF antenna substrate for microwave and/or millimeter wave applications. Example applications include improved 77 gigahertz and 77-81 gigahertz automotive radars, and 94 GHz mm-wave imaging apparatus.

Examples of the present invention include improved electrical interconnections between an antenna and RF circuit such as a transmission and/or receiver electronic module. The antenna may be a planar array antenna, for example a microstrip planar antenna array. An improved electrical interconnection comprises a transition via through an antenna substrate, and may comprise first and second waveguides on different sides of the antenna substrate connected by a transition via passing through the substrate between via pads terminating the waveguides. The antenna substrate is preferably a low-loss substrate at the operating frequencies of the antenna, for example comprising a liquid crystal polymer or other material.

In some examples of the present invention, an antenna substrate has an antenna (such as an antenna array) supported on a first side, and an RF circuit module and a printed circuit board (PCB) proximate the other (second) side. A transition via passes through the antenna substrate so as to interconnect an antenna feed on the first side of the substrate with RF electronics on the second side of the substrate. The antenna feed may, for example, comprise a waveguide such as a coplanar waveguide (CPW) and a microstrip line. Using a transition via, losses between the RF circuit and the antenna may be substantially reduced.

Hence, an apparatus for transmission and/or reception of microwave radiation comprises a low loss RF substrate, such as a liquid crystal polymer layer having a first side and a second side, an antenna array supported on the first side, an antenna feed supported on the first side, a transition via between the first side and the second side, the antenna feed interconnecting the transition via and the antenna array. The antenna feed may comprise a coplanar waveguide (CPW) proximate the transition via and a microstrip line between the CPW and the antenna. An RF electronic circuit may be proximate or adjacent the second side of the antenna substrate. Further, a circuit board may be proximate or adjacent to the antenna substrate, and may be mechanically associated with the antenna substrate, for example through a bonding layer. In some examples, the circuit board may have a similar composition to the antenna substrate. The circuit board may be bonded to a liquid crystal polymer layer used as the antenna substrate. Electronic circuitry, which may include digital and IF signal processing, a transmit/receive module, a digital signal processor, digital clock, temperature control, microprocessor, and further components, may be associated with one or more printed circuit boards bonded to or otherwise adjacent the liquid crystal layer.

In some examples of the present invention, one or more thermal vias may be provided through the antenna substrate for purposes such as heat sinking, for example using a thermal via to conduct heat away from a transmit/receive module on the second side of the antenna substrate to a metal sheet for heat rejection on the first side of the antenna substrate.

Examples of the present invention include an improved automotive radar including an antenna apparatus according to an embodiment of the present invention. The antenna array may be a patch antenna. The use of a transition via within the electrical interconnection between the antenna array and associated RF electronic circuit allows reduced losses associated with transmitted or received signals. Further, the use of a transition via may provide a simplified and low cost antenna module.

The term radar assembly may be used to describe a combination of the antenna array, an RF electronic circuit such as a transmit/receive module, associated control electronics, an antenna substrate such as a liquid crystal polymer layer, and associated printed circuit boards which may be used to support the associated control electronics. Examples of the present invention include improved radar assemblies in which the electrical interconnection between the RF electronics and the antenna includes a transition via through the antenna substrate.

An example apparatus comprises an antenna and a radio-frequency front end for a radar device, such as an automotive radar. Example apparatus comprise an antenna substrate in the form of a thin sheet having first and a second sides, an antenna on the first side of the antenna substrate, a radio-frequency circuit (RF circuit) on the second side of the antenna substrate, and a transition via passing through the antenna substrate. An antenna feed electrically interconnects at least part of the antenna and the transition via. The antenna feed may comprise a waveguide, such as a coplanar waveguide and/or other RF transmission line such as a microstrip line. The RF circuit may be flip-chip or flood mounted on the antenna substrate, on the opposite side of the antenna substrate from the antenna.

The RF circuit, such as a transmit/receive module, and the antenna are in electrical communication through the transition via and the antenna feed. The RF circuit may be electrically connected to the transition via by a connector waveguide, such as a second CPW, located on the second side of the antenna substrate.

A circuit board proximate the antenna substrate may be used to support an electronic control circuit in communication with the RF circuit. The circuit board may also have a conducting sheet that provides a ground plane for the antenna. Alternatively, the antenna substrate may be metal-clad on one or both sides and etched as necessary, or a ground plane may be introduced as a conducting sheet adjacent the second side of the antenna substrate.

The antenna substrate may comprise: an organic material, such as an organic resin; a liquid crystal polymer (LCP); other polymeric material such as a sheet comprising a polymer, a composite, or other polymeric material; an inorganic material such as a semiconductor, ceramic, glass, composite; or other material or combination thereof. For example, an antenna substrate may comprise one or more of the following: a liquid crystal polymer (LCP) such as Rogers ULTRALAM 3000 series LCP; a fluoropolymer-ceramic substrate, e.g. a micro-dispersed ceramic-PTFE composite such as CLTE-XT from Arlon, Cucamonga, Calif.; a PTFE glass fiber material such as Rogers RT 5880/RO 3003; LTCC (Low Temperature Co-Fired Ceramic); a semiconductor such as silicon or GaAs (gallium arsenide); a dielectric oxide such as alumina; a polyxylylene polymers parylene-N; a fluoropolymer, e.g. a polytetrafluoroethylene such as Teflon™ (DuPont, Wilmington, Pa.); Duroid, or other low-loss material at the frequency or frequency range of interest. The antenna may comprise a planar array of conducting patches on the antenna substrate.

In some examples, the transition via is impedance matched to the antenna feed. The antenna feed may comprise a waveguide, such as a coplanar waveguide (CPW). A (CPW) may comprise a conducting stripe located between a pair of grounded regions, the stripe being separated from the grounded regions by narrow gaps extending along the edges of the stripe. The pair of grounded regions for the CPW may be provided by a ground region extending around the via pad and the conducting stripe of the CPW. The ground region may be tapered to reduce return losses. The ground region may also have a smoothed edge. Shorting vias may be provided between the ground region and a ground plane on the second side of the antenna substrate, for example a ground plane associated with a waveguide (e.g. CPW) connection between the transition via and the RF circuit (and/or the antenna ground plane). In some descriptions, for conciseness, the term CPW is used to indicate the central conducting stripe of the waveguide structure. The antenna feed may comprise a CPW portion, having associated grounded regions, which transitions to a microstrip line as the edges of the grounded regions extend away from the conducting stripe. In some examples, the width of the central stripe of the CPW may be narrower than the that of the microstrip line, which can assist maintenance of a generally constant impedance through the antenna feed. In some examples, the central stripe of the CPW extends through a slot in the ground region. The capacitance of the via pads, combined with the self-inductance of the transition via, can be configured to give a transition impedance (e.g. 50 ohms) that is matched to that of the antenna feed, reducing losses compared with conventional approaches.

One or more transition vias may be used to interconnect the RF circuit and the antenna. In some examples, a single transition via is used to connect to a column of patches of a patch antenna array, or in other examples a single transition via can be used to connect to the entire antenna.

Hence, an example apparatus includes a radio-frequency front end for an automotive radar comprises an antenna substrate, an antenna, a radio-frequency circuit (RF circuit) supported by the antenna substrate, on the other side of the antenna substrate from the antenna, the antenna and RF circuit being electrically interconnected by a transition via passing through the antenna substrate. The electrical interconnection between the RF circuit and the antenna may include a connection waveguide between the RF circuit and the transition via, the transition via passing through the antenna substrate, and an antenna feed electrically interconnecting the transition via and at least part of the antenna. A circuit board adjacent the second side of the antenna substrate can be used to support an electronic control circuit in communication with the RF circuit. The circuit board and antenna substrate may be proximate, substantially adjacent, adjacent, or bonded together. The circuit board may further have a conducting sheet located to provide a ground plane for the antenna. The control circuit may comprise one or more of the following: a microprocessor/DLL, digital signal processor, digital clock, temperature control, data ports, and the like. In some examples, the circuit board may be a multilayer circuit board.

In some examples, the antenna substrate may form part of a protective housing for the circuit board, the protective housing being a non-metallic protective housing.

A transition via may be a electrical conductor passing through a hole in the antenna substrate. The transition via may have a generally cylindrical shape, for example as a solid cylinder or tube. For example, a transition via may have a diameter between 10 microns and 1 mm, and a length approximately equal to a thickness of the antenna substrate, for example the antenna substrate having a thickness of between 10 microns and 1 mm, for example between 25 and 500 microns, all ranges being inclusive.

An example method of transmitting and/or receiving signals to and/or from an automotive radar antenna comprises providing an RF circuit, providing an RF antenna supported by an antenna substrate, the antenna substrate being located between the RF antenna and the RF circuit, transmitting (and/or receiving) RF signals from the RF circuit to the RF antenna through an electrical interconnection path that includes at least one waveguide and a transition via. The electrical interconnection may include a connector waveguide, a transition via, and an antenna feed, the transition via passing through the antenna substrate. The transition via and the associated via patch may be configured so as to provide impedance matching along the electrical interconnection, for example between the transition via and to the antenna feed and/or between the transition via and the connector waveguide from the RF circuit.

### BRIEF DESCRIPTION OF THE FIGURES

FIG. 1 shows a cross section of an RF front end for an automotive radar including a transition via;

FIGS. 2A and 2B illustrate a proposed radar front end assembly, showing front and back views of a printed circuit board and liquid crystal polymer antenna substrate;

FIG. 2C shows a detailed view of part of a radar front-end assembly;

FIG. 3 further illustrates a transition between a first coplanar waveguide (CPW) on a first side of a liquid crystal polymer layer to a second CPW on the second side of the liquid crystal polymer layer, comprising a metal transition via through the low loss antenna substrate, in this example a liquid crystal polymer (LCP);

FIGS. 4A-C illustrate the pattern of conductors on the top and bottom of the antenna substrate, a via interconnecting first and second CP waveguides, and further showing ground tapering;

FIG. 5 illustrates improved S parameters for an antenna assembled using the improved transition via;

FIGS. 6A and 6B further illustrate tapering and smoothing of the ground conductors;

FIGS. 7A and 7B illustrate further configurations, including the use of shorting vias for a CPW line; and

FIG. 7C illustrates improved S parameters obtained using a transition via and shorting vias for the CPW line.

### DETAILED DESCRIPTION OF THE PREFERRED EMBODIMENTS

Examples of the present invention include apparatus and methods related to low cost, high performance transition vias on antenna substrates, in particular low loss RF substrates such as liquid crystal polymer based layers. Improved transitions according to embodiments of the present invention may, for example, be used in a three-dimensional (3D) RF front end of automotive radars. Other applications include any millimeter wave RF front end application, including 60 gigahertz WLAN/WPAN applications, communication systems, W band imaging and the like.

Examples of the present invention include improved RF front ends with reduced insertion and return loss. RF performance, in some examples, may be improved using a tapered ground plane and/or placing grounding vias in appropriate locations so as to suppress parasitic modes and substantially eliminate radiation loss.

Conventional automotive radars are relatively expensive and bulky. Conventionally, a metal frame is used to provide both packaging and support and also for interconnection between the planar array of the antenna and the RF front end using metalized waveguides. The overall thickness of a conventional radar is typically of the order of 5.5 centimeters when packaged, and approximately 2 centimeters unpackaged. In a conventional automotive radar, a metallic frame is used to provide metalized waveguide sections for transitioning signals from the MMIC to the antennas, for packaging and reduced cross torque, and also to provide mechanical support and cooling for the system. However, the use of a metal frame increases the cost of the system, especially due to the fact that the waveguide sections need to be polished in order to reduce losses at 77 gigahertz (or other operating frequency).

Further, conventional automotive radars require complex interconnection schemes. For example an antenna may be a planar microstrip array printed on a thin membrane. However typically the membrane is not suitable for supporting the MMIC so that the signal needs to be transitioned to a metalized waveguide. A second transition at the other end converts the waveguide mode to a microstrip mode. In a conventional microstrip waveguide, the substrate is alumina which is fairly expensive. The signal is then further transitioned to a millimeter wave PCB, and then fed into the LNA by a wire bond connection. Hence, the conventional interconnection scheme includes four different transitions from one type of transmission line to another. The complex conventional interconnection has problems with loss, noise, and reduced radar sensitivity and range. Further, bandwidth is reduced because a waveguide to microstrip transition typically has at most a 5 to 6 percent bandwidth. At 77 gigahertz, this corresponds to approximately 4 gigahertz. Hence, conventional radar is very sensitive to manufacturing tolerances, and extreme care and hence expense is needed to obtain satisfactory operation. During manufacture, multiple tests may be required, increasing production time and costs for each radar unit.

Transition vias have previously been used in high speed printed circuit boards, however these are limited to operations typically below 2 gigahertz, and are hence unsuitable for automotive radar applications.

Automotive radar performance using a conventional design may be improved using alternative substrates such as silicon, gallium arsenide alumina, or other inorganic substrate. However, fabrication of three-dimensional structures through such inorganic substrates is difficult and may be prohibitively expensive for mass produced automotive applications.

In examples of the present invention, an improved automotive radar includes an antenna array, RF electronic front end, and a transition between the RF electronic front end and the antenna array, the transition including a transition via through the antenna substrate used to support the antenna array. In examples of the present invention, the antenna substrate may be a low-loss material at operational frequencies, such as a liquid crystal polymer layer. The substrate may have for example, a thickness in the range 10 microns to 1 millimeter, in particular 50-500 microns, for example approximately 100 microns. The transition via may interconnect a waveguide or microstrip line used to communicate with the antenna array, and a second microstrip line, waveguide, or other connection used to communicate with the RF front end,

In some examples of the present invention, an antenna substrate is associated with, for example mechanically associated with, a printed circuit board used to support associated electronics, including electronic circuitry used to control the transmitted radar signal or to interpret received signals.

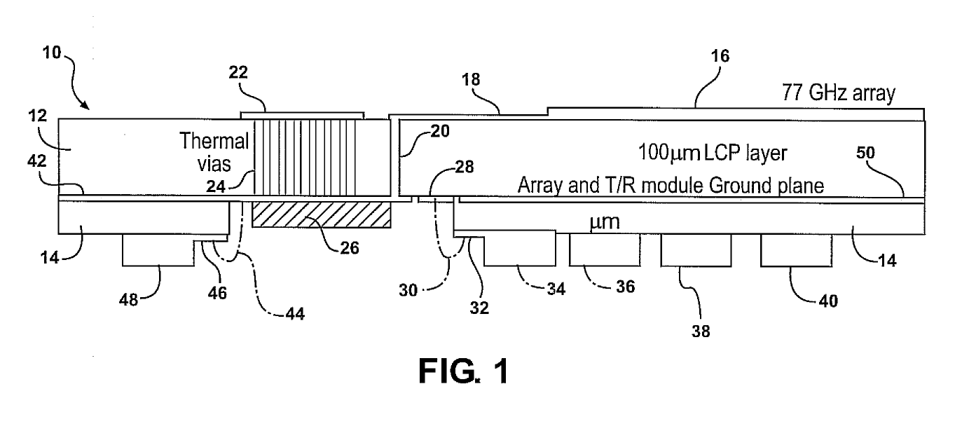

FIG. 1 shows a cross section of an example automotive radar front end. The figure shows an antenna substrate in the form of liquid crystal polymer (LCP) layer 12 used as an antenna substrate, the antenna substrate supporting an antenna array generally at 16. In this example, the antenna array is configured for 77 GHz operation. An antenna feed 18 (in this example comprising a microstrip line) runs from at least part of the antenna array to the transition via at 20. The figure shows a radio-frequency front-end circuit (RF circuit) in the form of a packaged flip chip mounted transmit/receive module at 26. Heat is conducted away from module 26 by thermal vias 24 through heat sink 22.

The RF circuit, in this example the transmit/receive module 26, handles RF signals. The electrical interconnection between the RF circuit and the antenna carries signals at the operating frequency of the radar, such as 77 GHz. Examples of the present invention include improved configurations in which losses in the electrical interconnection are reduced through the use of a transition via. The RF circuit may be operate as a mixer, so that electrical communication with the control circuit occurs at greatly reduced frequencies (e.g. <2 GHz) and may use conventional wire connections.

FIG. 1 also shows a printed circuit board 14 which is used to support associated electronic components such as a digital signal processor, digital clock, temperature control, microprocessor/DLL, DC and data ports. The layer shows at 14 may be a multilayer printed circuit board. Associated electronic components, such as a microprocessor, clock, and the like, are shown generally at 34, 36, 38, and 40. However the arrangement of such components on PCB 14 is not critical, and components can be combined into a single chip such as an ASIC. Wire bond connections such as 44 and 30 may be used for the communication of intermediate frequency (IF) and/or digital signals. These are at substantially lower frequencies than 77 gigahertz, and hence the improved transitions of the present invention are not required for the transmission of such signals. The PCB 14 may have a conducting layer 50 disposed thereon, the conducting layer providing a ground plane for the antenna array 16. However it is not necessary that the ground plane 50 is provided by a conducting layer on the PCB.

In some examples of the present invention, the PCB is bonded or otherwise laminated with the LCP 12. For example, a thin sheet of glue, e.g. 20-25 microns thickness of glue, may be used to bond the PCB to the LCP. The antenna may be a steering array, for example configured to transmit and/or receive radiation along an adjustable directional range. A transition via may be used for each column of antenna patches. In some examples, if the antenna is not a steering array, a single via may be used for the entire antenna.

The antenna feed may comprise a coplanar waveguide portion and/or a microstrip line. The antenna may comprise an array of conducting patches. The electrical connection between the RF circuit and the transition via may comprise a coplanar waveguide. The transition via 20 may interconnect first and second via pads on the upper and lower (as illustrated) sides of the antenna substrate.

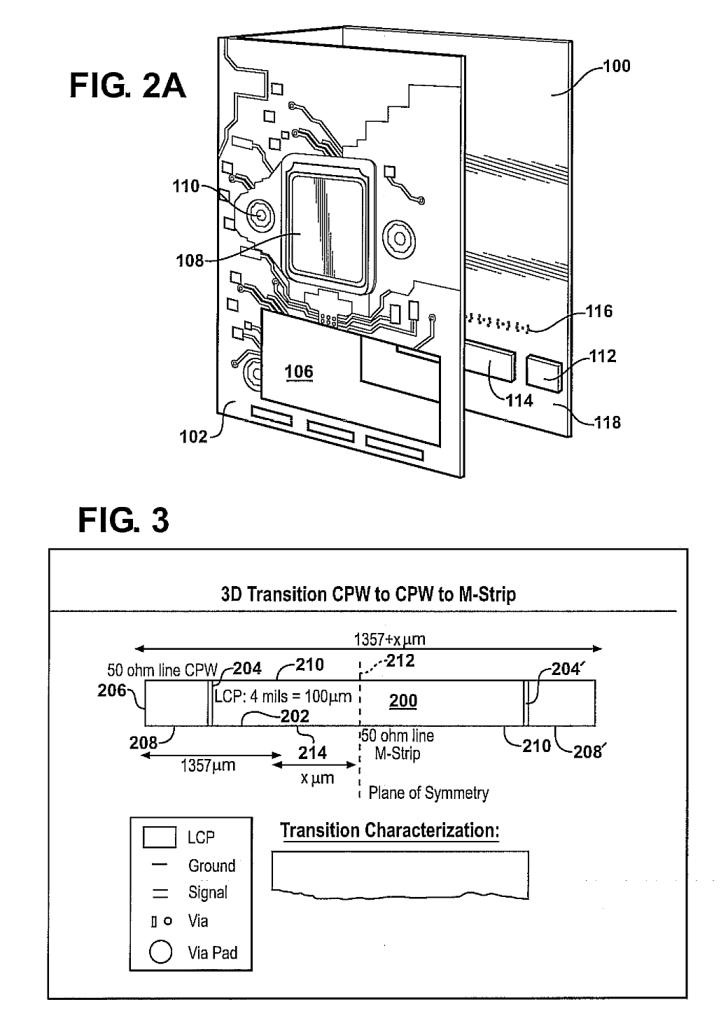

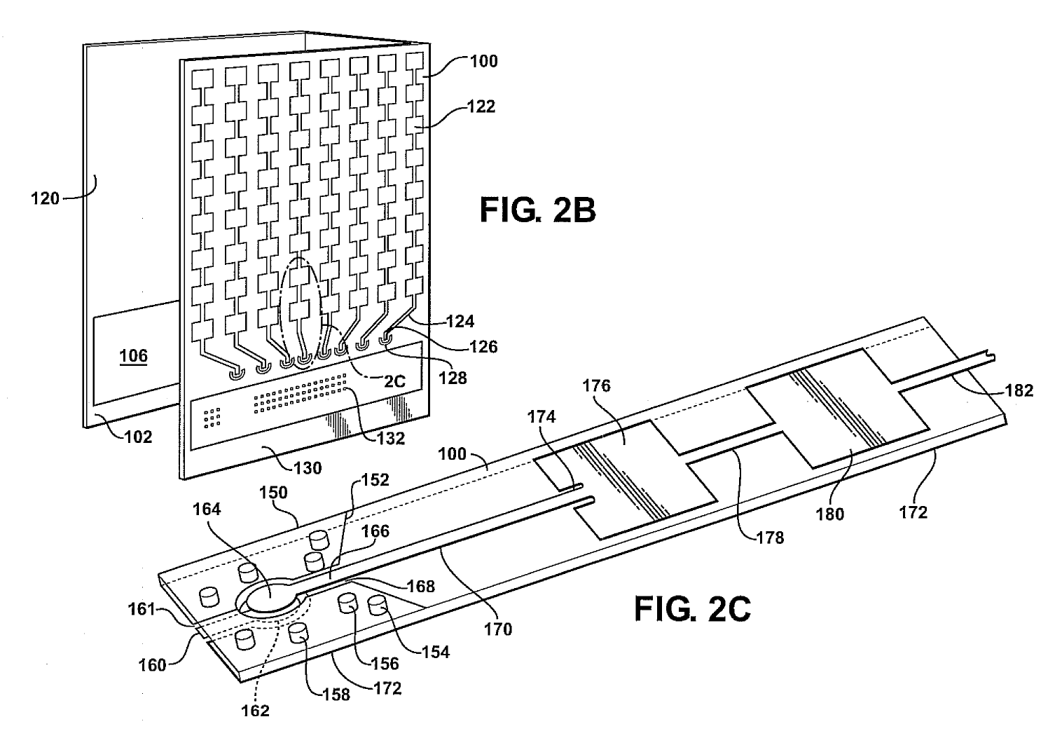

FIGS. 2A and 2B show top and bottom views of an improved configuration. The terms top and bottom are used for illustrative convenience and are not otherwise limiting. In this example, the term top view is used for a view towards the antenna array.

FIG. 2A shows a bottom view, showing printed circuit board 102 with an aperture 106 formed therein, control electronic circuitry 108, other components such as 110 being supported on the PCB. The RF circuit may be mounted to the second side of the antenna substrate within the aperture 106. FIG. 2A also shows a bottom view of the liquid crystal polymer 100 including transmit/receive modules 114 and 112. The 3D RF transition is also shown, comprising transition vias located at 116.

FIG. 2B shows a top view, showing antenna substrate 100, antenna array including patches such as 122, antenna feeds such as 124, transition vias such as 126, and top ground regions such as shown at 128. The conducting sheet 130 is used as a heat sink, and 132 is a thermal via used to conduct heat away from the RF front end modules.

FIG. 2C shows a detailed view of a possible configuration, showing a portion of an antenna substrate 100, in this example a liquid crystal polymer sheet having a thickness of 100 microns. As illustrated, the upper surface of the substrate supports the antenna patches, such as 176 and 178, though the terms upper and lower are not intended to be limiting. The figure shows a tapered ground region 150 on the upper surface, having an edge 152, shorting vias such as 154, 156, and 158, coplanar waveguide (CPW) 160 on the lower surface of the substrate, lower via pad 162, upper via pad 164, coplanar waveguide portion 166, and microstrip line 170. A via transition connects the upper and lower via pads 162 and 164, but is not seen in this illustration. The edge 152 of the ground region is at an oblique angle relative to the microstrip line 170.

In this example, the antenna feed comprises the coplanar waveguide 166 on the upper surface of the substrate extending from the via pad and extending between two air gaps through the tapered ground, and the microstrip line 170. The tapered ground region 150 is separated by a narrow gap 168 from the top via pad 164 and the CPW portion of the antenna feed. Similarly, the lower ground plane is separated by a narrow gap 161 from the coplanar waveguide 160 and lower via pad 162, and in this example the ground plane 172 extends under the antenna patches to provide a ground plane for the antenna. The antenna feed connects the transition via through the upper via pad 164 to the antenna patches through optional matching structure 174. The lower CPW may connect to RF electronics. The shorting vias connect the tapered ground region 150 on the top surface with the lower ground plane 172 on the lower surface, and allow reduction of edge radiation.

Here, the electrical connection from an RF circuit (not shown in FIG. 2C) to the antenna comprises a first coplanar waveguide (CPW) 162, a transition via (not shown), second CPW 172, and microstrip line 156. The top CPW and microstrip line interconnect the transition via (e.g. centered within an interconnecting top and lower via pads) to the antenna array, e.g. including antenna patches 152 and 154. The RF circuit can be located so as to connect to CPW 162, on the lower surface of the LCP. A transition via may be used to drive one column (or, equivalently, row) of antenna patches.

For a waveguide based system, the antenna substrate may be a three-dimensional (3D) multilayer organic substrate, for example a liquid crystal polymer substrate though other organic materials such as organic resins may also be used. Preferably the antenna substrate has low loss for signal propagation at 77 gigahertz and is low cost. In some examples of the present invention, the antenna substrate, such as a liquid crystal polymer, may be used as an interposer material, for example as a substrate on which various components can be mounted. Further the antenna substrate may be used for packaging, for protecting the electronic circuitry from humidity, dust, cross torque, and the like. In such examples, the metallic frame can be replaced with materials of substantially lower cost.

Examples of the present invention include one or more transition vias between the RF front end and the antenna. In some examples, a single transition via is used to replace the multiple waveguide-microstrip transitions used in conventional automotive radar front ends. In some examples, a plurality of transition vias can be used, for example as shown in FIGS. 2A and 2B. The use of transition vias reduces the insertion loss of the interconnection between the antenna and the low noise amplifier DNA), significantly improving the noise and sensitivity of the radar.

The use of transition vias allows a very high bandwidth, which significantly increases manufacturing tolerances. In some examples, the bandwidth exceeded 40%, which is 10 times greater than that achieved by conventional waveguide transitions used in automotive radars. The automotive radar may not require such a wide bandwidth for operation. However, the wide bandwidth significantly reduces variability of radar performance with manufacturing parameter variations. The antenna substrate may be a liquid crystal polymer layer, and in some examples may be a multilayer substrate.

In some examples of the present invention, via pads and gaps on the first and second sides of the antenna substrate may be optimized so as to match the series inductance of the transition via with a waveguide impedance, and to maintain a generally constant characteristic impedance throughout the transition. For example a 50 ohm characteristic impedance transition may be obtained through suitably shaped and configured via pads and/or gaps. Examples of the present invention include transitions having very broadband response (more than 40% bandwidth), an improvement of an order of magnitude over conventional waveguide transitions used in automotive radars.

The configuration of via pads, gaps, and ground regions may be used to modify the impedance (such as inductance) of a transition via so as to impedance match the adjacent waveguide structures. The characteristic impedance of the interconnection between the RF front end and the antenna can be made consistent, for example approximately 50 ohms throughout. This approach allows a greatly reduced return loss compared with conventional configurations, and may be less than −18 decibels across a wide bandwidth.

The number of transition vias used may be the minimum number required to obtain a particular RF performance. One or more vias may be used. For example, one via may be used per column of patches within an antenna array.

In some examples, other vias may be placed around the transition via to improve antenna characteristics. These additional vias, such as shorting vias, may be used to suppress parasitic parallel plate modes from propagating in the substrate. The vias may also be used to obtain a very efficient mode conversion from a microstrip line to a coplanar waveguide (CPW) mode, for example as illustrated in FIG. 2C.

In some examples, the use of a tapered ground allowed significant reduction, and in some examples substantial elimination, of radiation loss due to the open end effect of the via pads. The number and location of vias may be optimized for the frequency of operation, for example 77 gigahertz. Further, the tapering shape of the ground may be optimized. Similar designs can be used with any high frequency substrate, and examples of the present invention are not restricted to liquid crystal polymer antenna substrates.

FIG. 3 is a further illustration, showing transition vias such as 204 and 204′ used to interconnect CPWs on the first and second sides of a liquid crystal polymer substrate. In this example the antenna array is supported on the first side of the substrate, in this illustration the lower side. In this illustration, there is symmetry around the central dashed line 212. Antenna patches can be arranged in an array, with array elements fed from left or right (as illustrated). The figure shows antenna substrate 200 (LCP), 50 ohm line CPWs 202 and 206B vias 204 and 204′, ground region 208, and ground plane 210. In this FIG. 208, 210, and 208′ represent ground regions. A 50 ohm line M strip (microstrip) line 214 extends from 50 ohm line CPW 202 to a similar CPW close to via 204′. Structures such as those shown in FIG. 3 were fabricated and used for evaluation of transition via configurations, which may for example as used to interconnect CPWs on different sides of an antenna substrate. In this example, two transition vias may be evaluated together, but in a radar apparatus only a single transition via may be needed for interconnection of an RF circuit and an antenna array.

FIG. 3 is a side cross section of an example 3D transition configuration, including a transition via, which was evaluated for use in a radar apparatus, but which may also be used in other millimeter-wave and microwave applications. In this example, the LCP 200 has a thickness of 4 mils, or 100 microns. The dielectric constant of the LCP may be approximately 3. The metal used is copper, though other conducting layers may be used. The input and output transmission lines (CPW and microstrip) are both 50 ohms. In examples of the present invention, the configuration of the via 204 can be made so that the transition via is also approximately 50 ohms, reducing the return loss for the overall system. In examples, the circular via pad and/or the gaps around the via pad may be optimized so as to minimize field reflections and improve impedance matching. For example, a via pad radius of 9 mils was used, and the centered via had a radius of 3 mils. The holes for the vias may be obtained using mechanical drilling or any other approach. The evaluated structure includes two vias, allowing the response of a single transition via to be evaluated by dividing the measured response by two.

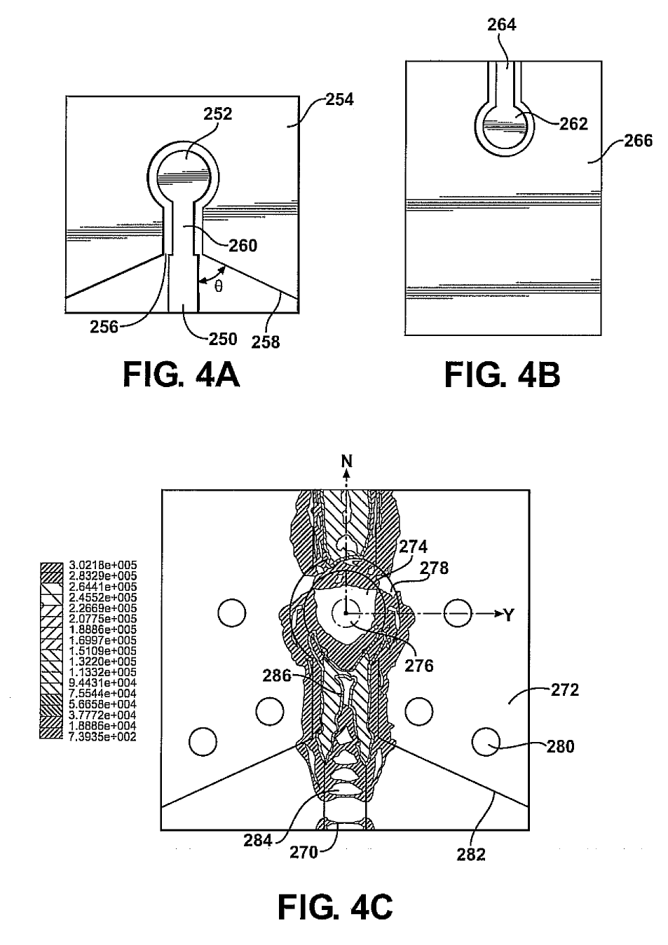

FIGS. 4A-4C show top and bottom views of a possible 3D transition, which may be used in a radar apparatus or other application. FIG. 4A shows a top view (here, the top view shows the side having the antenna), including microstrip line 250, via pad 252, gap 256 and surrounding ground region 254 having a gap 256 around the via pad 252 and waveguide portion 260, and tapered ground edge 258. The antenna feed includes the microstrip line 250 and waveguide portion 260 connected to a transition via. The ground region 254 in this example is tapered, as shown by the edge of the ground region 258 which has an angle of less than 90 degrees relative to the direction of elongation of the microstrip line (for example, angle θ in the range 10-80 degrees, more particularly 45-80 degrees). Hence, the tapered ground region has an edge that is oblique relative to the microstrip line. The transition via (not shown) is centered within via pad, and electrically connects to a via pad 262 on the lower surface of the antenna substrate. The configuration of via pad around the transition via, the waveguide portion of the antenna feed 260, and microstrip line The configuration shown in FIG. 4B shows a bottom view, including via pad 262, waveguide 264, and ground plane 266.

FIG. 4C is a view of a configuration similar to that shown in FIG. 4A, in this case further having shorting vias. The figure shows field distributions around the transition via 276 centered within via pad 274 having gap around it 278. As can be seen, edge radiation is suppressed and return loss is minimized. Hence, an interconnection between the RF front end and antenna array using a transition via may have lower loss, allowing low noise antenna operation and improved device functionality. The figure also shows shorting vias 280 configured so as to improve field distributions. The shorting vias help reduce radiation from the ground region. The tapered ground region is shown at 272, and the tapering of the ground is shown by the obliqueness of the ground edge 282 relative to the indicated X axis at the top of the figure, which is parallel to the antenna feed 270, which includes microstrip line 270 and waveguide 286. A narrow gap 278 separates the ground region 272 from the via pad and the waveguide portion 286 of the antenna feed. The thickness if the waveguide portion of the antenna feed is less than that of the microstrip line, so as to maintain a 50 ohm impedance throughout the antenna feed. This is also shown in FIG. 4A. The diameter of the via pad, and hence capacitance, can be configured to combine with the self-inductance of the via transition to gives a transition impedance of approximately 50 ohms, or other desired impedance that matches the antenna feed. This improves performance by allowing a 50 ohm impedance to be maintained through the connection between the RF circuit and antenna elements. The addition of shorting vias such as 280 at the feed (e.g. proximate the transition via) improved the RL (reflection loss) by −3.5 decibels in the range 60-90 GHz. (In FIGS. 4A-4C, and 6A-7B, the terms top and bottom are not limiting, but match those used in FIG. 2A-2C. The top view is the side of the antenna substrate supporting the antenna elements). The figure shows the central stripe of the CPW portion of the antenna feed as narrower than the microstrip line, enabling a generally constant impedance to be maintained. The shorting vias reduce or substantially eliminate electromagnetic radiation from the edges of the CPW portion and via pad. Shorting vias can also be used for a CPW used to connect a second via pad to the RF circuit.

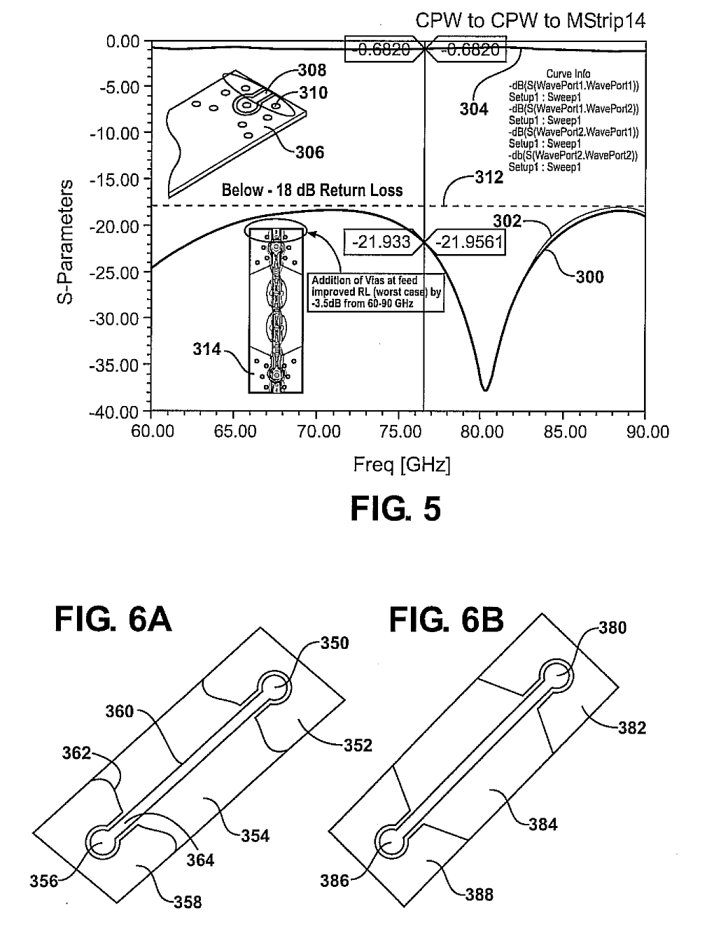

FIG. 5 illustrates the reflection loss of the improved configuration discussed above in relation to FIGS. 4A-4C. The figure shows S values as a function of frequency at 300 and 302 for forward and backward propagation respectively through the via. Curve 304 represents a conventional configuration. The inset 306 illustrates a via configuration similar to that shown in FIG. 4B, comprising waveguide input 308, ground 306, and vias 310 which short through to the ground on the opposed face of the liquid crystal polymer substrate, for example corresponding to those shown in FIG. 4C at 280. The inset at 314 is an illustration of a configuration according to an embodiment of the present invention, substantially the same as that shown in FIG. 4C reflected about an axis of symmetry through the center as shown in FIG. 3. The discussion of 4C above is adequate to describe this configuration. In FIG. 5 the lower curves 300 and 302 represent the return loss, and the upper curve 304 represents the insertion loss for the structure discussed relative to the inset 306 and FIG. 4C.

FIGS. 6A and 6B illustrate further possible approaches to tapering of the ground. FIG. 6A shows via pads at 350 and 356 interconnected by waveguide/microstrip line 360 on a liquid crystal polymer substrate 354. The ground regions 352 and 358 are both tapered and sharp edges are removed by smoothing, as shown by the form of the ground edge 362. In this example evaluated structure, the ground region is separated by a narrow air gap from the via pad and the waveguide 364. In an example antenna, a single via transition may be used, with an antenna feed comprising the waveguide 364 and a microstrip line. This configuration may be combined with the use of shorting vias.

FIG. 6B shows a similar configuration on liquid crystal polymer 384, the vias being located approximately at 380 and 386, the ground regions being 382′ and 388. This approach to tapering and smoothing of the ground regions improves performance of the device. A return loss of less than −18 decibels (corresponding to dashed line 312) was obtained for the frequency range 60-90 gigahertz. The results were obtained for a CPW to CPW-microstrip transition within an evaluation structure, as illustrated in FIGS. 6A and 6B.

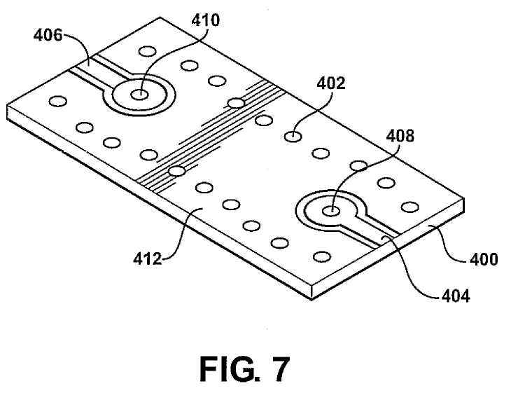

FIGS. 7A and 7B further illustrate the use of shorting vias for the CPW line. FIG. 7A is a top view showing coplanar waveguides (CPWs) 406 and 404, vias 408 and 410 surrounding by via pads, and location of shorting vias for example at 402. FIG. 7B shows a bottom view, with vias being located approximately at 422 and 426, surrounded by via pads, having a waveguide interconnection 424, and surrounded by a ground region 420. The shorting vias for the CPW line interconnect the ground 420 of FIG. 7B and the ground 412 of FIG. 7A.

FIGS. 7A and 7B illustrate a CPW-CPW transition using a transition via. In addition to the use of shorting vias, the CPW section is in the center of the structure. The shorting vias suppress parasitic parallel plate modes created due to close proximity of the two ground planes 412 and 420. The S parameter results for this structure are shown in FIG. 7C, as curve 430. The return loss is −16 decibels and the insertion loss (curve 432) −0.6 decibels for the frequency range 60 gigahertz through 90 gigahertz.

Hence, transition vias can be used for improved low loss transitions between a CPW on one side of a substrate, and a CPW on a second side of a substrate. In some examples, for example as discussed in relation to the evaluated structures of FIG. 4, a transition via provides an improved low loss transition between a CPW and a CPW-microstrip line. The conventional lithography process used for the above examples allowed a minimum via diameter of 75 microns, and minimum shorting via spacings of 450 microns. Higher resolution processes can be used, in which case the shorting via diameter can be reduced, and shorting vias can be placed closer together.

### Further Aspects

Examples of the present invention include apparatus and methods for providing 3D transitions on a low loss antenna substrate such as a liquid crystal polymer (LCP) substrate, in particular for use with mm-wave applications such as 77 GHz and 77-81 GHz automotive radars. The use of transitions including transition vias allow improved 3D radio frequency (RF) front-ends fabricated on multi-layer, low-cost organic substrates such as LCP.

Examples of the present invention include a 3D vertical transition that connects the antenna array with the RF circuit, for example a silicon-germanium chip such as a packaged flip-chip mounted transmit receive (T/R) module. An RF front end comprises elements, such as an RF circuit, between the antenna and an intermediate frequency (IF) stage. In some examples, the RF circuit may comprise one or more of the following: a low-noise amplifier (LNA), band-pass filter to eliminate spurious electrical noise, a mixer (or frequency down-converter), and one or more matching circuits, such as waveguide matching circuits.

Examples of the present invention include a radar apparatus including a 3D vertical RF transition. Examples of the present invention include transitions that have one or more of the following features: wideband operation (for example, generally constant insertion loss between 60 GHz and 90 GHz, or other frequency range, allowing fabrication and assembly tolerances to be increased); low insertion loss (i.e. low loss between the antenna and the T/R module, for example less than −16 dB), low return loss (for example, less than −0.5 dB), small size (for example, diameters of less than 1 mm, allowing co-location of multiple transitions in close proximity to the chip), low cost (for example through a reduced number of vias, such as one via per column of antenna elements, or a single via for an antenna), and compatibility with commercially available LCP design rules.

Some examples of the present invention relate to automotive radars. Typically, a conventional automotive radar is packaged using a polished metallic frame. The frame provides the metalized waveguide sections that are needed for transitioning the signal from the MMIC to the antenna. A received signal is transitioned from a microstrip to a metalized waveguide (transition 1), then transitioned again from the waveguide to a microstrip (transition 2). Conventionally, the second microstrip is printed on alumina, which is a fairly expensive microwave substrate. The received signal is then transitioned to a mm-wave PCB substrate (transition 3: microstrip-to-CPW, wirebond, CPW-to-microstrip). Finally the signal is fed into the low noise amplifier (LNA) by a wirebond connection (transition 4). The interconnection scheme includes four different transitions from one type of transmission line to another. Such an interconnection scheme suffers from increased loss, which, severely affects the overall noise figure of the system and deteriorates the radar sensitivity and range. Waveguide-to-microstrip transitions have at most 5-6% bandwidth due to the use of resonating stubs, correspond to about 4 GHz of bandwidth for automotive radars. A conventional radar is hence very sensitive to manufacturing tolerances and extreme care needs to be taken in order to ensure good operation. This translates to multiple tests during the fabrication and assembly processes which increase the production time and costs for each unit.

In examples of the present invention, such as waveguide based systems, a 3-dimensional (3D) multi-layer organic antenna substrate (such as a liquid crystal polymer (LCP) or other organic resin) may be used. Preferably, the antenna substrate exhibits low loss signal propagation at the operating frequency (or frequency range), such as 77 GHz. The use of organic substrates, such as LCP or an organic resin, allows elimination of waveguides using costly and difficult to process inorganic substrates such as alumina. LCP is a low cost but high frequency substrate which allows the creation of multi-layer substrates for e.g. mm-wave applications.

For example, a liquid crystal polymer substrate may be a single-component liquid crystal polymer sheet, a polymeric material such as a composite, blend, or other combination including a liquid crystal polymer component, a combination of liquid crystal polymers, or other material including a liquid crystal polymer. Example LCP membranes may comprise a synthetic non-liquid-crystalline support material, such as a membrane (for example comprising a polyimide, polyethersulfone, polyethylene terephthalate, polyethylene, polypropylene, polyester, fluoropolymer such as a fluoroethylene polymer or copolymer, and the like) supporting an LCP component. Example LCP components include thermotropic liquid crystal polymers such as aromatic liquid crystalline polyesters, aromatic carboxylic acid polymers, and the like.

The antenna substrate, such as an LCP sheet, may be used as both an interposer material (a substrate upon which different components can be mounted), and a package (for protecting from humidity, dust, and crosstalk). Therefore, the conventional metallic frame can be entirely replaced, if desired, with materials of significantly lower cost.

A single transition via can replace the multiple waveguide-microstrip transitions currently used in automotive radars. This allows reduced insertion loss of the interconnection between the antenna and the low noise amplifier, which can significantly improve the overall noise figure and sensitivity of the radar.

In some examples, the bandwidth of a transition via is more than 40%, which is 10 times better than what can be achieved by conventional waveguide transitions. A wider bandwidth increases the manufacturing tolerances and allows reduced manufacturing costs, e.g. through improved yield and reduced and/or simplified testing.

In some examples, the series inductance of the transition via allows impedance matching and reduced insertion losses. In a representative example, the series inductance of a 4-mil diameter transition via was matched with appropriate capacitances created by the via pads and the connecting coplanar waveguide (CPW) structures. This allows the characteristic impedance of the line connection to remains close to 50 Ohms throughout, giving a very low return loss (less than −18 dB) across a wide bandwidth. The number of transition vias may be reduced to that necessary in order to achieve acceptable RF performance, for example at 77 GHz.

Vias may also be strategically placed around the transition via to suppress parasitic parallel plate modes from propagating in the substrate, and/or achieve a very efficient mode conversion from a microstrip line mode to a CPW mode.

A tapered ground may be used to eliminate the radiation loss due to open-end effects of the via pads. The number and location of the vias on the tapered ground may be optimized for 77 GHz operation. The tapering of the ground may be optimized as well. Tapering and/or smoothing of the CPW top grounds and the placement of the vias may be configured to for close to minimum return loss and suppression of edge radiation. The latter is especially useful at mm-wave frequencies because it may be a significant source of losses.

A wide band 3D transition of a CPW-CPW-MStrip Line and a CPW-CPW Line were designed. Similar designs may be used for any high frequency substrate, and examples of the present invention are not restricted to LCP sheets.

The antenna substrate (e.g. LCP antenna substrate) may have, for example, a thickness between 10 microns and 1 mm, in particular between 50 microns and 200 microns, for example approximately 100 microns. In a representative example, the antenna substrate had a thickness of 4 mils and a dielectric constant of approximately 3. (1 mil=25.4 microns and 4 mil=101.6 microns). The metal used for the transition via (and/or waveguide or antenna elements) may be copper gold, silver, platinum, an alloy thereof or in some examples a conducting polymer or other conductor may be used.

Input and output transmission lines (e.g. CPW, microstrip, other planar transmission line, or any other desired transmission line) may both have the same impedance, such as 50 ohms, and a transition via may be configured having an impedance close to that value, for example within 20%. Impedance matching of the transition via to other transmission line elements, such as coplanar waveguides, reduces return loss for the overall system. The circular via pad and the gaps around it may be configured for lower field reflections and improved impedance matching. In a representative example, a via pad radius was 9 mils, and the transition via was centered in the via pad and had a radius of 3 mils. Hence, the via pad radius can be configured so as to reduce reflection and insertion losses.

Via formation in the antenna substrate may be obtained using mechanical drilling, which allows reduced cost. However, other hole-forming methods may be used, such as laser drilling, etching, stamping, and the like. A minimum number of vias and short traces may be used to reduce substrate area requirements and the overall package size.

Wideband operation allows reduced sensitivity of an apparatus to fabrication and assembly tolerances. Wideband operation was observed, in some examples a return loss of less than −18 dB was observed from 60-90 GHz. In some examples, a low insertion loss of less than −0.5 dB, in particular less than −0.7 dB, was observed from 60-90 GHz. The described transition via may also be lower frequencies, such over the range 1 GHz-100 GHz. Example apparatus may be within fabrication tolerances of existing fabrication houses for preparation of via pads, via dimensions, via spacings, trace widths, and gaps between traces, so that expensive fabrication processes such as laser drilling may be avoided.

Examples of the present invention include a CPW-CPW transition between waveguides on opposite sides of a substrate using a transition via through the substrate. Shorting vias may be used between the CPW sections to suppress a parasitic parallel plate mode that may occur due to the proximity of the two ground planes on opposed sides of the substrate (e.g. LCP). In some examples, the electrical interconnection between an antenna and a transmit/receive circuit and an antenna comprises a microstrip line, a first waveguide, a transition via, and a second waveguide, where the first and/or second waveguide may be a CPW.

Examples of the present invention include an improved RF front end for automotive radar, any mm-wave RF front-end (e.g. 60 GHz WLAN/WPAN applications, communication systems, W-band imagers, and the like), and methods and dedicated short range radar communication (DSRC) devices. In some examples, an RF circuit may comprise a monolithic microwave integrated circuit, MMIC. Examples of the present invention include microwave applications (e.g. 1 GHz-300 GHz), in particular millimeter wave (e.g. 30 GHz-300 GHz) antennas, including radar apparatus such as automotive radars.

Examples of the present invention allow excellent RF performance (through low insertion and return loss) by using a tapered ground plane and by placing grounding vias in appropriate locations in order to suppress parasitic modes and eliminating radiation loss. Furthermore, the via pads and gaps may be optimized so as to match the series inductance of the transition via and maintain a desired impedance (such as 50 ohms characteristic impedance) throughout the transition. This allows a very broadband response (for example, more than 40% bandwidth) which is 10 times better than obtained with the conventional waveguide transitions used in automotive radars.

Some examples of the present invention include apparatus and methods for creating 3D transitions on an LCP substrate for use with mm-wave applications such as 77 GHz and 77-81 GHz automotive radars. Examples antenna substrates include a 3D multi-layer organic substrate, such as liquid crystal polymer (LCP), which exhibits low-loss signal propagation at 77 GHz and at the same time low cost, which allows for elimination of the costly waveguide components. Some examples use a single transition via in place of one or more waveguides used to interconnect the RF front end with the antenna. LCP sheets may be obtained from commercial sources, for example the ULTRALAM 3000 series LCP circuit material from Rogers Corp., Chandler, Ariz. For example, according to manufacturer's specifications, ULTRALAM 3850 is a low loss RF substrate having a dissipation factor of less than 0.003 at 10 GHz and 23° C., and may be used as an antenna substrate in examples of the present invention.

Examples of the present invention allow elimination of multiple waveguide-microstrip transitions as currently used in conventional automotive radars. In some examples, use of liquid crystal polymer as an antenna substrate is combined with use of a single transition via in place of one or more waveguides used in a conventional RF apparatus.

A method of transmitting signals to an automotive radar antenna comprises providing an RF circuit, providing an antenna supported by an antenna substrate, the antenna substrate being a polymeric substrate; and transmitting RF signals from the RF circuit to the antenna through an electrical interconnection, the RF circuit and the antenna being located on opposite sides of the antenna substrate, the electrical interconnection comprising a transition via passing through the antenna substrate. The electrical interconnection may comprise a connector waveguide, the transition via, and an antenna feed, the connector waveguide transmitting signals from the RF circuit to the transition via, the antenna feed transmitting signals from the transition via to at least part of the antenna. The transition via may be configured to be impedance matched to the antenna feed so as to reduce a transmission loss within the electrical interconnection.

The invention is not restricted to the illustrative examples described above. Examples are not intended as limitations on the scope of the invention. Changes therein, other combinations of elements, and other uses will occur to those skilled in the art. The scope of the invention is defined by the scope of the claims.

Having described our invention, we claim:

1. An apparatus, the apparatus being a radar apparatus comprising:
an antenna substrate, having a first side and a second side;
an antenna disposed on the first side of the antenna substrate;
a transition between the first and second sides of the antenna substrate, the transition including:
a first via pad supported by the first side of the antenna substrate;
a second via pad supported by the second side of the antenna substrate; and
a transition via passing through the antenna substrate, connecting the first and second via pads; and
an antenna feed supported by the first side of the antenna substrate, the antenna feed electrically interconnecting the first via pad and at least part of the antenna,
the transition via, first via pad, and second via pad being configured so that the transition is impedance matched to the antenna feed.

2. The apparatus of claim 1, the first side of the antenna substrate supporting a ground region,
the ground region partially surrounding the first via pad and being spaced apart from it by a gap.

3. The apparatus of claim 2, the apparatus further comprising shorting vias between the ground region and a ground plane adjacent the second side of the antenna substrate.

4. The apparatus of claim 2, the antenna feed comprising a coplanar waveguide and a microstrip line, the coplanar waveguide ending at the first via pad,
the ground region extending around the first via pad and the coplanar waveguide.

5. The apparatus of claim 4, the ground region being tapered, the ground region having an edge extending at an oblique angle relative to the microstrip line.

6. The apparatus of claim 4, the an edge extending at an oblique angle relative to the microstrip line having a rounded profile.

7. The apparatus of claim 4, the shorting vias being positioned so as to suppress edge radiation from the coplanar waveguide.

8. The apparatus of claim 1, the capacitance of the via pads and self-inductance of the transition via giving a transition impedance of 50 ohms.

9. The apparatus of claim 1, the apparatus further comprising:
a radio-frequency circuit (RF circuit) supported on the second side of the substrate, and
a co-planar waveguide on the second side of the antenna substrate electrically interconnecting the RF circuit and the second via pad.

10. The apparatus of claim 9, the electrical interconnection between the RF circuit and the antenna having a loss of less than −18 db between 60 GHz and 90 GHz.

11. The apparatus of claim 9, the RF circuit being flip-chip mounted to the second side of the antenna substrate.

12. The apparatus of claim 9, further comprising a circuit board adjacent the second side of the antenna substrate,
the circuit board supporting an electronic control circuit in communication with the RF circuit.

13. The apparatus of claim 1, the antenna substrate comprising a polymer.

14. An apparatus, the apparatus being a radar apparatus comprising:
an antenna substrate, having a first side and a second side;
an antenna disposed on the first side of the antenna substrate, an transition between the first side and the second side, the transition comprising:
a first via pad supported by the first side of the antenna substrate;
a second via pad supported by the second side of the antenna substrate; and
a transition via passing through the antenna substrate, connecting the first and second via pads;
an antenna feed supported by the first side of the antenna substrate, the antenna feed interconnecting the first via pad and at least part of the antenna;
a ground region supported by the first side, partially surrounding the first via pad and being spaced apart from the first via pad by a gap; and
a ground plane substantially adjacent the second side of the antenna substrate; and
a plurality of shorting vias electrically interconnecting the ground region and the ground plane.

15. The apparatus of claim 14, the antenna comprising an array of conducting patches,
the ground plane partially surrounding the second via pad and extending beneath the array of conducting patches so as to provide a ground plane for the antenna.

16. The apparatus of claim 14, the antenna feed comprising a coplanar waveguide portion and a microstrip line,
the coplanar waveguide portion extending between the first via pad and the microstrip line,
the ground region extending around and being spaced apart from the first via pad and the coplanar waveguide.

17. The apparatus of claim 16, the shorting vias being positioned to suppress losses from the coplanar waveguide.

18. The apparatus of claim 16, the ground region having an edge extending away from the microstrip line at an oblique angle to the microstrip line,
the oblique angle being between 10 degrees and 80 degrees, inclusive.

19. The apparatus of claim 16, the ground region having edges extending away from each side of the microstrip line at an oblique angle to the microstrip line, the oblique angle being between 45-80 degrees.

20. The apparatus of claim 14, the apparatus comprising a plurality of transition vias, each transition via interconnecting the RF circuit and a column of antenna patches.

21. An apparatus, the apparatus being a radar apparatus comprising
an antenna substrate, having a first side and a second side;
an antenna, comprising conducting elements supported by the first side of the antenna substrate;
a radio-frequency circuit (RF circuit) substantially adjacent the second side of the antenna substrate;
an electrical interconnection between the antenna and the RF circuit, the electrical interconnection including:
a transition via passing through the antenna substrate and connecting a first via pad on the first side and a second via pad on the second side;
an antenna feed, located on the first side of the antenna substrate and electrically interconnecting the via pad and at least part of the antenna; and
a waveguide connection, located on the second side of the antenna substrate and electrically interconnecting the RF circuit and the second via pad;
a ground region on the first side, the ground region having an edge extending around the first via pad and a portion of the antenna feed, the edge then extending away from the antenna feed at an oblique angle;
a ground plane substantially adjacent the second side of the antenna substrate; and
a plurality of shorting vias between the ground region and the ground plane,
the electrical interconnection between the antenna and the RF circuit presenting a generally constant impedance so as to reduce

22. The apparatus of claim 21, the electrical interconnection having a return loss of less than −18 decibels for the frequency range 60-90 gigahertz.

23. The apparatus of claim 21, the apparatus being a radio-frequency front end assembly for a radar,
the antenna being a patch antenna comprising an array of conducting patches supported by the first side of the antenna substrate,
the apparatus comprising a plurality of an electrical interconnections, each electrical connection connecting to a group of antenna elements.

24. The apparatus of claim 21, the antenna feed comprising a coplanar waveguide portion and a microstrip line,
the coplanar waveguide portion comprising a conducting stripe having portions of the ground region proximate each side thereof,
the microstrip line electrically interconnecting the first coplanar waveguide with the antenna.

25. The apparatus of claim 24, the conducting stripe of the coplanar waveguide being narrower than the microstrip line.

26. The apparatus of claim 21, the apparatus further comprising a circuit board adjacent the second side of the antenna substrate,
the circuit board supporting an electronic control circuit in electrical communication with the RF circuit, the control circuit comprising a microprocessor,
the circuit board further supporting a conducting sheet located so as to provide the ground plane.

27. The apparatus of claim 21, the antenna substrate forming part of a housing for the RF circuit and the circuit board.

28. The apparatus of claim 21, the transition via comprising an electrical conductor,
the transition via having an outer diameter between 10 microns and 1 mm inclusive,
the transition via having a length approximately equal to an antenna substrate thickness,
the antenna substrate being a generally planar sheet, the antenna substrate thickness being between 10 microns and 1 mm inclusive.
